(19) United States
(12) Patent Application Publication
(10) Pub. No.: US 2022/0088595 A1
(43) Pub. Date: Mar. 24, 2022

(54) INTEGRATED MICROFLUIDIC EJECTOR CHIPS

(71) Applicant: Hewlett-Packard Development Company, L.P., Spring, TX (US)

(72) Inventors: Fausto D'Apuzzo, Palo Alto, CA (US); Steven Barcelo, Palo Alto, CA (US); Anita Rogacs, San Diego, CA (US)

(73) Assignee: Hewlett-Packard Development Company, L.P., Spring, TX (US)

(21) Appl. No.: 17/415,066

(22) PCT Filed: Jun. 4, 2019
(86) PCT No.: PCT/US2019/035351

§ 371 Date: Jun. 17, 2021

(51) Int. Cl. B01L 3/00; G01N 21/65; G01J 3/44; G01J 3/28

(52) U.S. Cl. CPC B01L 3/502715; G01N 21/658; G01J 3/44; B01L 2200/16; B01L 2200/025; B01L 2300/0663; B01L 2300/0867; B01L 2200/04; G01J 2003/2826; B01L 2300/0819

(57) ABSTRACT

Integrated microfluidic ejector chips and methods of use are provided. An example of an integrated microfluidic ejector chip includes a first set of microfluidic ejectors fed with a reference solution, and a second set of microfluidic ejectors fed with a sample solution. The first set of microfluidic ejectors and the second set of microfluidic ejectors are disposed on the integrated microfluidic ejector chip to print a pattern of proximately located spots on a sensor.

### BACKGROUND

Plasmonic sensing is a powerful tool for trace level chemical detection. However, quantitation may be difficult due to variation in sensors. Various techniques have been tested to improve the quantification, such as incorporating an active compound into the structure of a plasmonic sensor, or incorporating enhanced testing of sensors.

### DESCRIPTION OF THE DRAWINGS

Certain exemplary embodiments are described in the following detailed description and in reference to the drawings, in which:

FIG. 1 is a schematic diagram of a process for the calibration of a plasmonic sensor via the dispensing of multiple spots, each at different concentrations, from a single microfluidic ejector die, in accordance with an example;

FIG. 2 is a drawing of a system for using a plasmonic sensor to determine a calibration curve, measure a concentration of an analyte, or both, in accordance with an example;

FIG. 3A is a drawing of a microfluidic ejector chip that includes two sets of microfluidic ejectors, each ejecting different concentrations of an analyte, in accordance with an example;

FIG. 3B is a drawing of a plasmonic sensor showing the pattern of spots generated using the microfluidic ejector chip of FIG. 3A, in accordance with an example;

FIG. 4 is a drawing of a microfluidic ejector chip that includes on-chip dilution elements, in accordance with an example;

FIG. 5A is a drawing of a microfluidic ejector chip that may be used to dispense a pattern of spots of solutions from three reservoirs onto a plasmonic sensor, in accordance with an example;

FIG. 5B is a drawing of a plasmonic sensor with a pattern of spots generated by the microfluidic ejector chip of FIG. 5A, in accordance with an example;

FIG. 6A is a drawing of a microfluidic ejector chip that may be used to dispense a pattern of spots onto a plasmonic sensor, in accordance with an example;

FIG. 6B is a drawing of a linear pattern of spots generated by the microfluidic ejector chip of FIG. 6A, in accordance with an example;

FIG. 7A is a drawing of a microfluidic ejector chip that may be used to dispense a pattern of spots onto a plasmonic sensor, in accordance with an example;

FIG. 7B is a drawing of a circular pattern of spots generated by the microfluidic ejector chip of FIG. 7A, in accordance with an example;

FIG. 8 is a drawing of a plasmonic sensor with a pattern of spots formed by a more complex arrangement of microfluidic ejectors, in accordance with an example;

FIG. 9 is a schematic drawing of a microfluidic ejector chip including a number of interspersed nozzles that may be used to form a pattern on a plasmonic sensor, in accordance with an example;

FIG. 10 is a process flow diagram of a method for using a microfluidic ejector chip that can print multiple simultaneous concentrations on a plasmonic sensor, in accordance with an example; and

FIG. 11 is a process flow diagram of another method for using a microfluidic ejector chip and sensor to determine the concentration of a test solution, in accordance with an example.

### DETAILED DESCRIPTION

Plasmonic sensors, including surface enhanced Raman spectroscopy (SERS) sensors, are powerful tools for trace level chemical detection, but often suffer from significant variation between measurements, making quantification difficult. Methods to address this include incorporating reference standards in the fabrication process or exposing multiple sensors to generate sufficient statistics, but these approaches can be complicated and expensive.

To perform sensor calibration, the surface density of the target analyte may be varied. Accordingly, the dispensing of multiple concentrations is desirable. However, implementing this using multiple dispense-heads may involve more manual work and may be less cost-effective. The ability to dispense multiple concentrations from multiple nozzles on a single dispense-head onto the sensor area would be useful. Further, this would improve alignment and reproducibility of the spots on the sensor area.

Techniques described herein use ink jet dies that are designed with nozzle positions and fluid routing to directly pattern a plasmonic sensor, such as a surface enhanced Raman spectroscopy (SERS) sensor, with an array of spots for quantification. The techniques described herein are not limited to plasmonic sensors, but may be used with other types of surface active sensors, such as fluorescence sensors, absorption sensors based on transflectance, and the like. Accordingly, the techniques may be performed without using an x-y stage, which simplifies equipment and alignment.

For calibration purposes, it is desirable to dispense a varied set of concentrations of the reference solutions, analyte solutions, or both. Further, multiple sets of concentrations series of the target analyte, calibration solutions, or both, may be used for determining concentrations of complex mixtures. In examples described herein, a microfluidic ejector die is designed to feed different sets of microfluidic ejectors from different reservoirs. Further, the designs may be used in printing applications to allow the dispensing of a small multi-color pattern without using a moving stage, or other moving parts.

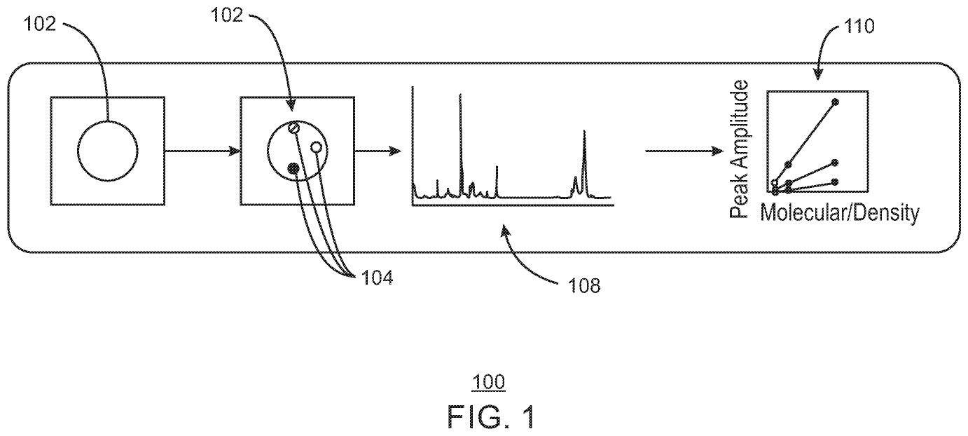

FIG. 1 is a schematic diagram of a process 100 for the calibration of a plasmonic sensor 102 via the dispensing of multiple spots 104, each at different concentrations, from a single microfluidic ejector die, in accordance with an example. In the present techniques, the surface molecular density of the multiple spots 104 is controlled by the concentration of each of the multiple spots 104. In some examples, the analyte solution is diluted on the microfluidic ejector die before being dispensed by the microfluidic ejectors. The molecular density is calculated 108 from the dilution factors, and is used for calibrating a sensor response curve 110.

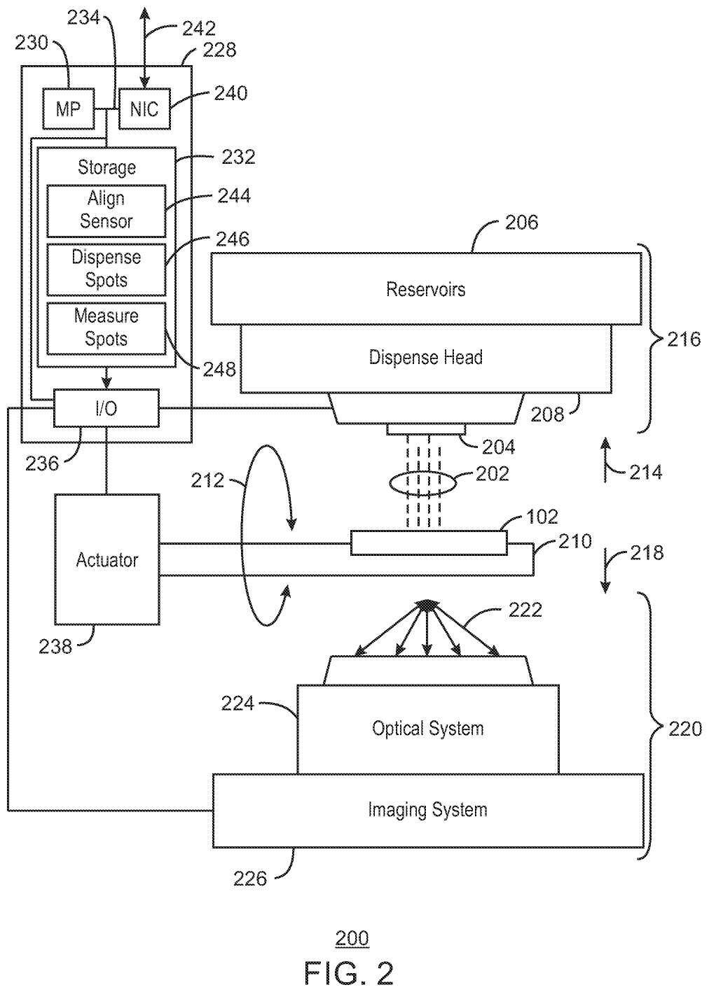

FIG. 2 is a drawing of a system 200 for using a plasmonic sensor 102 to determine a calibration curve, measure a concentration of an analyte, or both, in accordance with an example. In this example, the system 200 dispenses droplets 202 of each of a number of multiple concentrations of a calibration solution onto the plasmonic sensor 102 from a different microfluidic ejector on a microfluidic ejector chip 204. The multiple concentrations of the calibration solution may be provided from reservoirs 206 that are fed to the microfluidic ejector chip 204 through fluidic channels in a dispense head 208. In some examples, a limited number of reservoirs 206, such as a single calibration reservoir, or sample reservoir, and a single dilution reservoir, may be used to feed mixing elements in the dispense head 208 or on the microfluidic ejector chip 204, itself.

In this example, the plasmonic sensor 102 is supported by a platform 210 that may be used to rotate 212 the plasmonic sensor 102 between two facing positions. In a first position 214, the plasmonic sensor 102 faces the dispensing system 216, including the microfluidic ejector chip 204. As described herein, the microfluidic ejector chip 204 may be based on thermal inkjet technologies. Piezoelectric ejector technologies, and the like. In the first position 214, spots of different concentrations are applied to the plasmonic sensor 102.

In the second position 218, the plasmonic sensor 102 is moved to face a spectral analysis system 220. The spectral analysis system 220 may focus light 222 to and from an optical system 224 of the spectral analysis system 220 on an imaging plane aligned with the plasmonic chip. The optical system 224 may direct excitation illumination, such as illumination from a laser source, monochromator, multiple LEDs, and the like, on the plasmonic sensor.

The system 200 is not limited to a rotating platform. In some examples, a sliding platform may be used. Accordingly, the spots of different concentrations, forming the pattern, are applied in a first position, then the sliding platform slides the sensor to the second position for detection. In this example, a solenoid may be used to move the platform from the first position to the second position.

Further, the optical system 224 includes optical objectives to collect light 222 emitted (e.g. scattered) from the spots on the plasmonic sensor 102, and direct that light 222 to an imaging system 226. In various examples, the imaging system 226 is a spectrometer, such as a Raman spectrometer or a fluorimeter, among others, with hyperspectral-imaging capability, for example, using line-scan imaging or single-point rastering. In other examples, the imaging system 226 is a hyperspectral camera that can collect spectral data for an entire image.

The system 200 includes a control system 228 that is used to control and collect data. The control system 228 includes a microprocessor 230 that executes instructions from a data store 232. The microprocessor 230 is coupled to the data store 232 over a bus 234, which may be a commercial bus, such as a PCIe implementation, or a proprietary bus, such as a system-on-a-chip (SoC) bus. In some embodiments, the data store 232 is a nonvolatile memory for both operating programs and long-term storage. In other embodiments, the data store 232 includes both volatile memory for operating programs, and a long-term data store, such as a flash memory.

An I/O system 236 may couple to the microprocessor 230 through the bus 234. The I/O system 236 may be used to control an actuator 238 that rotates 212 the platform 210 holding the plasmonic sensor 102. The I/O system 236 also couples to the dispensing system 216 to control the dispensing of droplets 202 onto the plasmonic sensor 102. In this example, after dispensing the droplets 202 onto the plasmonic sensor 102 the I/O system 236 rotates the platform 210 until the plasmonic sensor 102 faces the spectral analysis system 220. The I/O system 236 is used to collect data from the imaging system 226 of the spectral analysis system 220. A network interface controller (NIC) 240 may be included and coupled to the microprocessor 230 over the bus 234 to allow the transfer of control information and data 242 between the control system 228 and external systems.

The data store 232 may include a number of code modules that include code to direct the microprocessor 230 control the operation of the spectral analysis system 220. In this example, an align sensor module 244 includes code to direct the microprocessor 230 to control the actuator 238 to rotate the plasmonic sensor 102, for example, to face towards the dispensing system 216, or to face towards the spectral analysis system 220. A dispense spots module 246 includes code to direct the microprocessor 230 to instruct the align sensor module 244 to rotate the plasmonic sensor 102 to face the dispensing system 216, and to dispense the droplets 202 to form the spots on the plasmonic sensor 102. A measure spots module 248 includes code to direct the microprocessor 230 instruct the align sensor module 244 to rotate the plasmonic sensor 102 to face the spectral analysis system 220, then to collect spectral data on the spots, generate a calibration curve, and determine the concentration of an analyte.

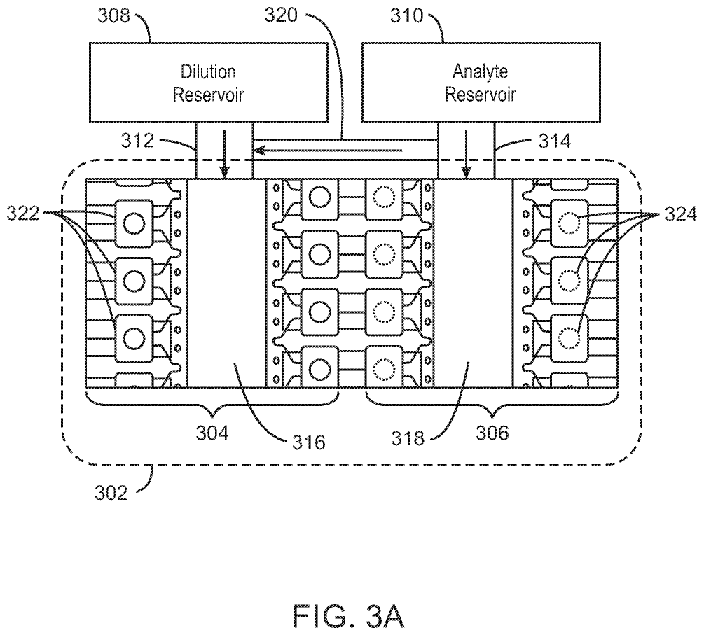

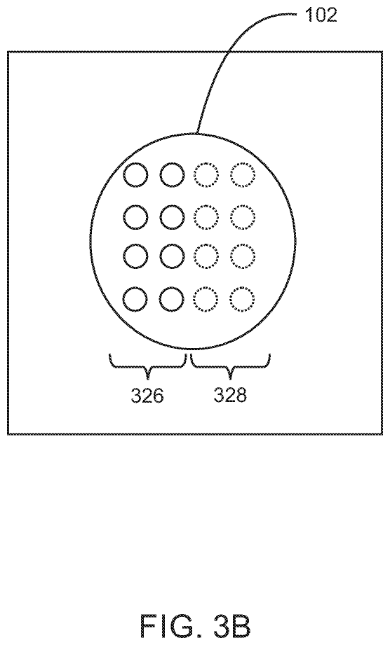

FIG. 3A is a drawing of a microfluidic ejector chip 302 that includes two sets of microfluidic ejectors 304 and 306, each ejecting different concentrations of an analyte, in accordance with an example. A dilution reservoir 308 holds a dilution solvent and an analyte reservoir 310 holds the analyte solution. In this example, the routing from the reservoirs 308 and 310 is performed by fluidically coupling the reservoirs 308 and 310 through flow channels 312 and 314 to slots 316 and 318 in the silicon substrate of the microfluidic ejector chip 302.

A fluidic coupling 320 from the flow channel 314 of the analyte reservoir 310 to the flow channel 312 of the dilution reservoir 308 allows a portion of the analyte solution to mix with the dilution solvent, forming a low concentration solution of the analyte. In other examples, the two sets of microfluidic ejectors 304 and 306 may pull solution from the slots 316 and 318, wherein the mixing ratio of the flow is based on the geometry, for example, the length and diameter of the fluidic coupling between the two sets of microfluidic ejectors 304 and 306 and the slots 316 and 318. In some examples, an inertial pump is embedded in a flow channel to move the solution and facilitate the blending.

The low concentration solution is fed to the slot 316 of a low concentration set of microfluidic ejectors 304 to be dispensed onto the plasmonic sensor. To simplify the drawing, not all of the microfluidic ejectors 322 in the low concentration set of microfluidic ejectors 304 are labeled. The undiluted analyte solution is fed through the flow channel 314 fluidically coupling the analyte reservoir 310 to the slots 318 of the high concentration set of microfluidic ejectors 306. The undiluted analyte solution is then dispensed through the microfluidic ejectors 324 of the high concentration set 306. As for the low concentration set of microfluidic ejectors 304, not all of the microfluidic ejectors 324 in the high concentration set of microfluidic ejectors 306 are labeled, to simplify the drawing.

FIG. 3B is a drawing of a plasmonic sensor 102 showing the pattern of spots generated using the microfluidic ejector chip 302 of FIG. 3A, in accordance with an example. A first set of spots 326 corresponds, in this example, to the low concentration set 304 dispensed by microfluidic ejectors 322. A second set of spots 328 corresponds to the high concentration set 306 of microfluidic ejectors 324.

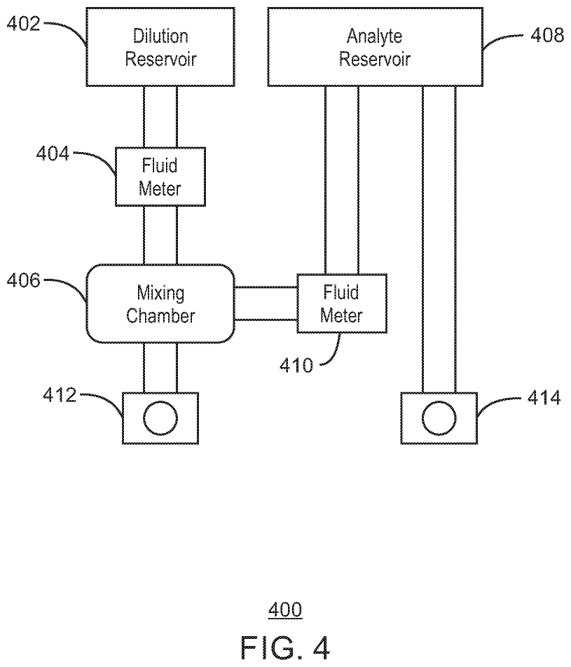

Systems for mixing the solutions are not limited to that shown in FIG. 3. Any number of other arrangements may be used, including the use of multiple reservoirs, each holding one concentration of the analyte solution. Other arrangements can include that described with respect to FIG. 4.

FIG. 4 is a drawing of a microfluidic ejector chip 400 that includes on-chip dilution elements, in accordance with an example. A dilution reservoir 402 may be formed into the chip to hold a dilution solvent, for example, used to change the concentration of an analyte solution. The dilution reservoir 402 may be refilled, for example, using a syringe to push fluid through a valve, a septum, and the like. The dilution reservoir 402 may include a secondary valve to allow excess material, such as gases or fluids, to pass back out of the dilution reservoir 402, allowing the dilution reservoir 402 to be rinsed. In some examples, the dilution reservoir 402 is pressurized to force fluid out of the dilution reservoir 402. In one example, the dilution reservoir 402 is filled using a “sip tip” sampling mechanism to draw material from a container into the dilution reservoir 402.

The dilution reservoir 402 may couple to a dilution fluid meter 404, or fluid control device, to control the amount of fluid moving from the dilution reservoir 402 into a mixing chamber 406. The dilution fluid meter 404 may be a microelectronic mechanical system (MEMS) valve configured to allow a metered amount of fluid to flow from the dilution reservoir 402 to the mixing chamber 406, for example, if the dilution reservoir 402 is pressurized. In other examples, the dilution fluid meter 404 is a MEMS pump, such as a microscopic positive displacement pump based on a gear design, a microfluidic pump based on a thermal ink jet design, or other types of pumps. In some examples, the dilution fluid meter 404 may combine these elements with a flowmeter, such as a thermal pulse flowmeter which measures the flow of a fluid by the speed at which an electrode cools down as fluid flows past. The mixing chamber 406 may be an active mixing chamber, in which energy is used to mix the two fluids with each other, or a passive mixing chamber in which diffusion between the two fluids causes the mixing.

An analyte reservoir 408 holds an analyte solution, such as a calibration solution or a target material solution. The analyte reservoir 408 may be as described with respect to the dilution reservoir 402, for example, including systems for syringe filling, pressurized flow, or sip tip filling, among others.

The analyte reservoir 408 is fluidically coupled with the mixing chamber 406 through an analyte fluid meter 410. The analyte fluid meter 410 may be as described with respect to the dilution fluid meter 404.

The fluid meters 404 and 410 may be used to ratio the amounts of the dilution solvent and analyte solution to adjust the concentration in the mixing chamber 406. In some examples, this is performed by controlling the amount of each of the solutions that are fed to the mixing chamber 406 by the fluid meters 404 and 410, for example, if the fluid meters are fluid control devices based on pumps. In other examples, the fluid meters 404 and 410 control the amount of each of the solutions that are fed to the mixing chamber 406 by controlling an amount of time that each of the fluid meters 404 and 410 are open, for example, if the fluid meters are fluid control devices based on MEMS valves.

The mixing chamber 406 feeds the diluted solution to a microfluidic ejector 412. The microfluidic ejector 412 may be a thermal ink jet ejector, or a piezoelectric ejector, or based on other MEMS technologies.

In one example, using the system shown in FIG. 4, two stock solutions are charged to the reservoirs 402 and 408. A calibration standard is charged to the analyte reservoir 404 and the dilution solvent is charged to the dilution reservoir 402. The solutions are mixed and fed into the mixing chamber 406, from which they are dispensed by the microfluidic ejector 412. In this example, an analyte microfluidic ejector 414 is coupled to the analyte reservoir 408 to directly dispense the analyte solution without dilution. Droplets, for example, of about 10 picoliters to about 30 picoliters, or about 20 picoliters (pL) in volume, are dispensed onto desired locations on sensors, for example, on proximate spots dispensed by the microfluidic ejectors 412 and 414. Examples described herein are not limited to a single set of mixing elements on the microfluidic ejector chip 400, or a single pair of microfluidic ejectors 412 and 414.

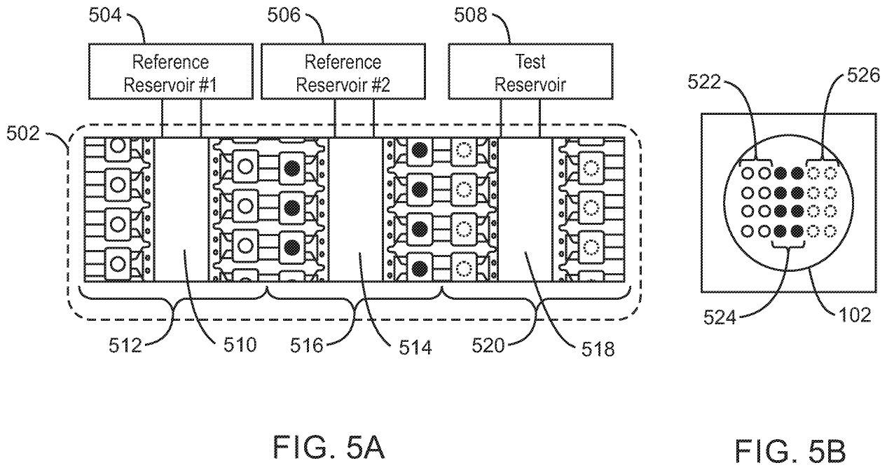

FIG. 5A is a drawing of a microfluidic ejector chip 502 that may be used to dispense a pattern of spots of solutions from three reservoirs 504, 506, and 508 onto a plasmonic sensor 102, in accordance with an example. In this example, a first reference reservoir 504 feeds a first reference solution into slot 510 that feeds the first reference solution to a first group of microfluidic ejectors 512. A second reference reservoir 506 feeds a second reference solution into a slot 514 that feeds the second reference solution to a second group of microfluidic ejectors 516. A test reservoir 508 feeds a test solution into a slot 518 that feeds the test solution to a third group of microfluidic ejectors 520.

FIG. 5B is a drawing of a plasmonic sensor 102 with a pattern of spots generated by the microfluidic ejector chip 502 of FIG. 5A, in accordance with an example. In this example, a first set of spots 522 is deposited by the first group of microfluidic ejectors 512. A second set of spots 524 is deposited by the second group of microfluidic ejectors 516. A third set of spots 526 is deposited by the third group of microfluidic ejectors 520.

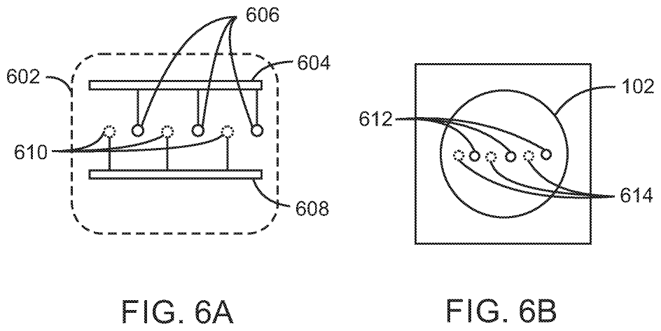

The configuration of the pattern of spots generated on a plasmonic sensor 102 can be modified by the arrangement of the slots and microfluidic ejectors. This is discussed further with respect to FIGS. 6-9.

FIG. 6A is a drawing of a microfluidic ejector chip 602 that may be used to dispense a pattern of spots onto a plasmonic sensor 102, in accordance with an example. In this example, a slot 604 feeds a first set of microfluidic ejectors 606. A second slot 608 feeds a second set of microfluidic ejectors 610. In this example, the first set of microfluidic ejectors 606 and the second set of microfluidic ejectors 610 are in line with each other. Accordingly, as shown in FIG. 6B, a linear pattern of spots is created on the plasmonic sensor 102, with spots 612 dispensed from the first set of microfluidic ejectors 606 in line with the spots 614 dispensed from the second set of microfluidic ejectors 610.

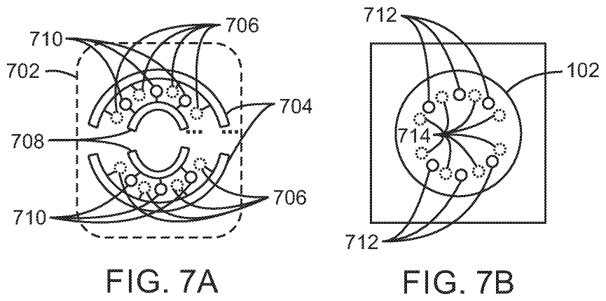

FIG. 7A is a drawing of a microfluidic ejector chip 702 that may be used to dispense a pattern of spots onto a plasmonic sensor 102, in accordance with an example. In this example, an outer arcuate slot 704 feeds a first set of microfluidic ejectors 706. An inner arcuate slot 708 feeds a second set of microfluidic ejectors 710. In this example, the first set of microfluidic ejectors 706 and the second set of microfluidic ejectors 710 are in line with each other along the circumference of the circle. Accordingly, as shown in FIG. 7B, a circular pattern of spots is created on the plasmonic sensor 102, with spots 712 dispensed from the first set of microfluidic ejectors 706 in line along the circumference of a circle with the spots 714 dispensed from the second set of microfluidic ejectors 710.

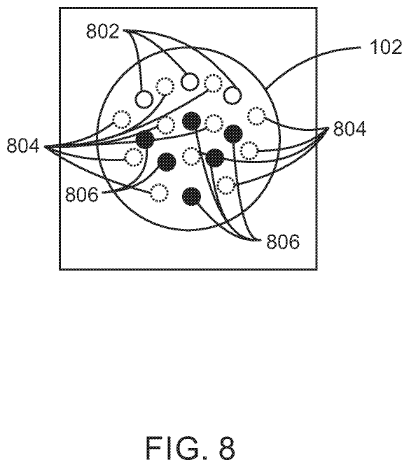

FIG. 8 is a drawing of a plasmonic sensor 102 with a pattern of spots formed by a more complex arrangement of microfluidic ejectors, in accordance with an example. In this example, a first set of spots 802, a second set of spots 804, and a third set of spots 806 are interspersed with each other across the plasmonic sensor 102. Each of the sets of spots 802, 804, and 806 are dispensed by an interspersed group of microfluidic ejectors fed from different reservoirs.

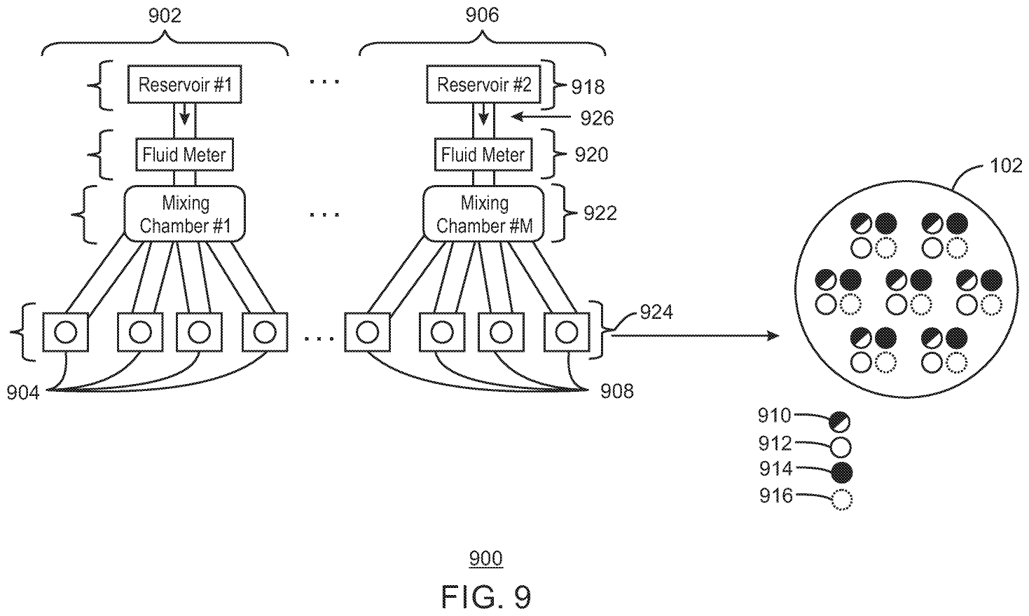

FIG. 9 is a schematic drawing of a microfluidic ejector chip 900 including a number of interspersed nozzles that may be used to form a pattern on a plasmonic sensor 102, in accordance with an example. In this example, microfluidic ejector chip 900 includes a number of fluid zones, each configured to provide fluid to an independent set of microfluidic ejectors, for example, a first fluid zone 902 provides fluid a first set of microfluidic ejectors 904, and a last fluid zone 906 provides fluid to a last set of microfluidic ejectors 908. In this example, four fluid zones are used to create interspersed spots 910, 912, 914, and 916 on a plasmonic sensor 102.

To perform this function, each of the fluid zones may be coupled to reservoirs 918 that may be located on the microfluidic ejector chip 900. In some examples, the reservoirs 918 are located off the microfluidic ejector chip 900, and coupled to the microfluidic ejector chip 900 by tubing or other fluidic couplings. Although each of the fluid zones may have an independent reservoir, the reservoirs 918 may be shared among the fluid zones, for example, with a reservoir providing solution through fluid meters 920 to mixing chambers 922 in other fluid zones. Accordingly, the number of the reservoirs 918 on the microfluidic ejector chip 900 may be less than the number of fluid zones. For example, a reservoir in the first fluid zone 902 may provide solution to a fluid meter in the first fluid zone 902, and to a fluid meter in another fluid zone to create mixtures or dilutions.

The fluid meters 920, mixing chambers 922, and microfluidic ejectors 924, are as described with respect to the fluid meters 404 and 410, the mixing chamber 406, and the microfluidic ejectors 412 and 414 of FIG. 4. In some examples, the reservoirs 918 are also located on the microfluidic ejector chip 900 as described with respect to the reservoirs 402 and 408. The fluidic couplings 926 that allow fluid flow between elements, such as the reservoirs 918 to the fluid meters 920 or from the mixing chambers 922 to the microfluidic ejectors 924 may be performed during the manufacturing of the microfluidic ejector chip 900, for example, by etching channels into the chip, or by forming channels in the over molding of the coatings used to form nozzles and other components of the microfluidic ejectors 924. The patterns of spots formed from the microfluidic ejectors of each set, may be made in any of the possible arrangements described herein, such as the pattern of spots on the plasmonic sensor 102 of FIG. 9, or the pattern of spots on the plasmonic sensor 102 of FIG. 8, among others.

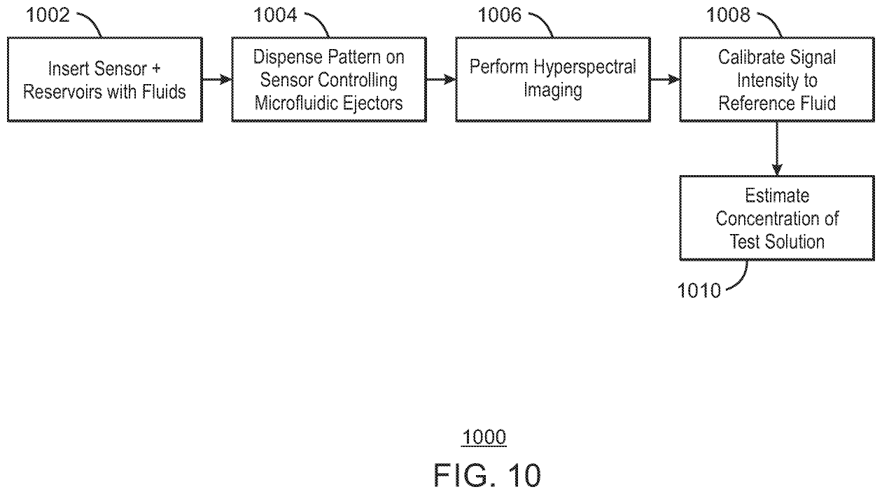

FIG. 10 is a process flow diagram of a method 1000 for using a microfluidic ejector chip that can print multiple simultaneous concentrations on a plasmonic sensor, in accordance with an example. The method 1000 may be implemented using the system described herein, for example, as described with respect to FIGS. 2-9.

The method 1000 begins at block 1002, when a plasmonic sensor is inserted into an analysis unit, for example, being attached to a platform 210, or placed in a holder attached to a platform 210, among others. The reservoirs are then filled with the appropriate fluids for the analysis, such as an analyte solution, a calibration solution, and a dilution solvent, among others.

At block 1004, a pattern is dispensed on a plasmonic sensor through microfluidic ejectors that dispense different concentrations onto the plasmonic sensor. This may be performed using any number of microfluidic ejector chip configurations, such as the microfluidic ejector chip 502 described with respect to FIG. 5A, or the microfluidic ejector chip 900 described with respect to FIG. 9.

At block 1006, hyperspectral imaging of the plasmonic sensor is performed. To perform this, after spots are dispensed onto the plasmonic sensor, a platform 210, as described with respect to FIG. 2, may be rotated to face the plasmonic sensor towards an imaging system. The imaging system may be a hyperspectral camera, or a line scan spectrometer, among others. The imaging system then collects a hyperspectral image of the plasmonic sensor to determine the spectra and signal intensity of the spots dispensed onto the plasmonic sensor. The angle between the microfluidic ejector direction and the optical interrogation axis can be 180 degrees as in FIG. 2, or alternatively 90 degrees, or for example 45 degrees or 135 degrees.

At block 1008, the signal intensity of the spots of the reference fluid, or calibration solution, may be determined. The signal intensities of the spots are used with the concentrations dispensed onto the plasmonic sensor to develop a calibration curve.

At block 1010, the signal intensity of the test solution, or analyte, may be determined. This may be used with the calibration curve to estimate the concentration of the test solution.

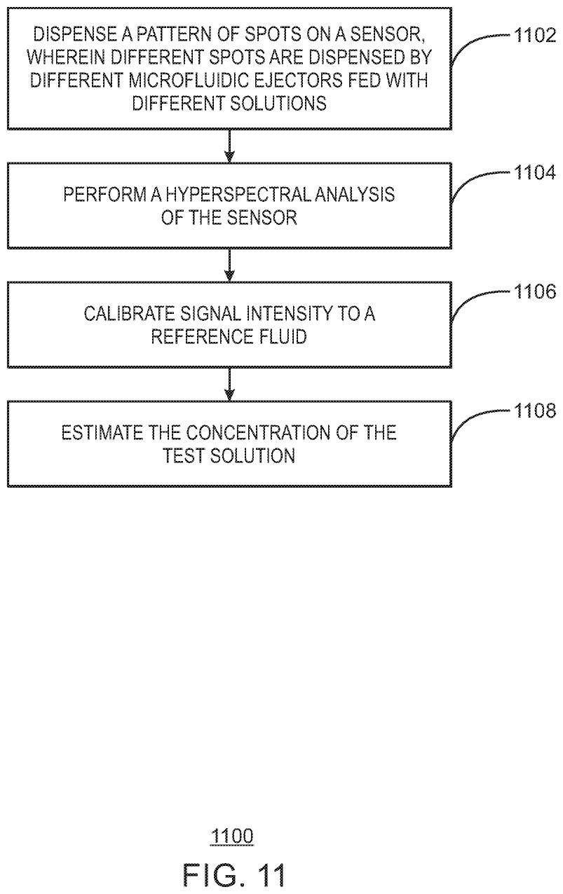

FIG. 11 is a process flow diagram of another method 1100 for using a microfluidic ejector chip and sensor to determine the concentration of a test solution, in accordance with an example. The method 1100 may be implemented using the systems described herein, such as the systems described with respect to FIGS. 2-9.

At block 1102, a pattern of spots is dispensed on a sensor, wherein different spots are dispensed by different microfluidic ejectors fed with different solutions. The different solutions may be different concentrations of a calibration solution or an analyte solution, for example, mixed in mixing elements on a microfluidic ejector chip, or mixed prior to the analysis and placed in reservoirs fluidically coupled to the microfluidic ejector chip.

At block 1104, a hyperspectral analysis of the sensor is performed. As described herein, this may be done by moving a platform to move a plasmonic sensor into the view of a hyperspectral imaging system. For example, the platform may be rotated as described herein. Further, as described herein, the method 1100 is not limited to plasmonic sensors, but may be used with other sensor technologies.

At block 1106, a signal intensity for a reference fluid is calibrated. This calibrates the response of the plasmonic sensor, which may then be used to calculate a calibration curve. At block 1108, the concentration of a test solution is estimated, for example, using the calibrated response of the reference fluid.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the scope of the present techniques.

What is claimed is:

1. A system, comprising an integrated microfluidic ejector chip, comprising:
a first set of microfluidic ejectors fed with a reference solution; and
a second set of microfluidic ejectors fed with a sample solution, wherein the first set of microfluidic ejectors and the second set of microfluidic ejectors are disposed on the integrated microfluidic ejector chip to print a pattern of proximately located spots on a sensor.

2. The system of claim 1, wherein the first set of microfluidic ejectors is interspersed with the second set of microfluidic ejectors.

3. The system of claim 1, wherein the integrated microfluidic ejector chip comprises a third set of microfluidic ejectors fed with a third solution.

4. The system of claim 3, wherein the third set of microfluidic ejectors is interspersed with the first set of microfluidic ejectors and the second set of microfluidic ejectors.

5. The system of claim 1, comprising:
a reference reservoir to contain the reference solution;
a sample reservoir to contain the sample solution;
a mixing chamber fluidically coupled to the first set of microfluidic ejectors;
a first fluid control device coupling the reference reservoir to the mixing chamber; and
a second fluid control device coupling the sample reservoir to the mixing chamber.

6. The system of claim 5, wherein the first fluid control device, the second fluid control device, or both, comprises a microfluidic pump.

7. The system of claim 5, comprising a fluidic coupling between the sample reservoir and the second set of microfluidic ejectors.

8. The system of claim 1, comprising a fluidic coupling between the first set of microfluidic ejectors and the second set of microfluidic ejectors, wherein the fluidic coupling allows a portion of the sample solution to be blended with the reference solution.

9. The system of claim 1, comprising a spectrometer with imaging capability.

10. The system of claim 1, comprising a hyperspectral camera.

11. The system of claim 1, comprising a platform to align the sensor with the microfluidic ejector chip for forming the proximately located spots, wherein the platform is to move the sensor chip to an imaging plane for analysis.

12. A method for analysis using an integrated microfluidic ejector chip, comprising:
dispensing a pattern of spots on a sensor, wherein different spots are dispensed by different microfluidic ejectors fed with different solutions;
performing a hyperspectral analysis of the sensor;
calibrating signal intensity to a reference fluid; and
estimating a concentration of the different solutions.

13. The method of claim 12, comprising filling reservoirs on the integrated microfluidic ejector chip.

14. The method of claim 12, comprising inserting the sensor into an imaging system.

15. The method of claim 12, comprising:
mounting the sensor on a moving mount;
moving the sensor to align with the integrated microfluidic ejector chip;
dispensing the pattern of spots on the sensor;
moving the sensor to align with an imaging system; and
performing the hyperspectral analysis.
